(19) United States
(12) Patent Application Publication
(10) Pub. No.: US 2026/0214172 A1
(43) Pub. Date: Jul. 23, 2026

(54) READING APPARATUS, READING METHOD, AND MEDIUM

(71) Applicant: BROTHER KOGYO KABUSHIKI KAISHA, Nagoya (JP)

(72) Inventors: Daisuke MATSUMOTO, Nagoya (JP); Takashi OHAMA, Iwakura (JP); Yasuo NISHIKAWA, Nagoya (JP)

(73) Assignee: BROTHER KOGYO KABUSHIKI KAISHA, Nagoya (JP)

(21) Appl. No.: 19/451,582

(22) Filed: Jan. 16, 2026

(30) Foreign Application Priority Data
Jan. 20, 2025 (JP) 2025-007997

(51) Int. Cl. H04N 1/00

(52) U.S. Cl. CPC H04N 1/00774; H04N 1/00748

(57) ABSTRACT

A reading apparatus includes a transparent plate; a reader; and a controller. The controller is configured to perform: an image generating process of reading an object placed on the transparent plate with scanning by the reader to generate an image corresponding to a result of the reading; a mark reading process of reading at least one first mark arranged overlapping with an edge of a sheet for adjustment placed on the transparent plate with the reader together with a region outside the sheet for adjustment; an extracting process of extracting at least one edge point on the edge of the sheet for adjustment based on the at least one first mark; and a correcting process of correcting a deviation in the image generated in the image generating process based on position information of the at least one edge point extracted in the extracting process.

### REFERENCE TO RELATED APPLICATIONS

This application claims priority from Japanese Patent Application No. 2025-007997 filed on Jan. 20, 2025. The entire content of the priority application is incorporated herein by reference.

### BACKGROUND ART

Conventionally, a technique is known in which a test chart with a detection mark formed thereon is read and correction of an error caused in a reading is performed by using a difference between predetermined segment lines in the image data obtained by the reading of the test chart.

### SUMMARY

In the above technique, the detection mark is disposed at a position away from an edge of a sheet. Thus, an error may occur in a case where a position of the edge of the sheet is calculated based on a result of detection of the detection mark, and thus performing reading correction with high accuracy is difficult.

The present disclosure aims to provide a reading apparatus, a reading method, and a medium each capable of performing reading correction with high accuracy.

An aspect of the present disclosure is a reading apparatus, including: a transparent plate; a reader; and a controller. The controller is configured to perform: an image generating process of reading an object placed on the transparent plate with scanning by the reader so as to generate an image corresponding to a result of the reading; a mark reading process of reading at least one first mark arranged overlapping with an edge of a sheet for adjustment placed on the transparent plate with the reader together with a region outside the sheet for adjustment; an extracting process of extracting at least one edge point on the edge of the sheet for adjustment based on the at least one first mark; and a correcting process of correcting a deviation in the image corresponding to the result of the reading generated in the image generating process based on position information of the at least one edge point extracted in the extracting process.

An aspect of the present disclosure is a reading method to be performed by a reading apparatus including a transparent plate and a reader. The method includes: an image generating process of reading an object placed on the transparent plate with scanning by the reader so as to generate an image corresponding to a result of the reading; a mark reading process of reading at least one first mark arranged overlapping with an edge of a sheet for adjustment placed on the transparent plate with the reader together with a region outside the sheet for adjustment; an extracting process of extracting at least one edge point on the edge of the sheet for adjustment based on the at least one first mark; and a correcting process of correcting a deviation in the image corresponding to the result of the reading generated in the image generating process based on position information of the at least one edge point extracted in the extracting process.

An aspect of the present disclosure is a non-transitory and computer-readable medium storing a program to be executed by a controller of a reading apparatus including a transparent plate, a reader, and the controller. The program is configured to cause the controller to perform: an image generating process of reading an object placed on the transparent plate with scanning by the reader so as to generate an image corresponding to a result of the reading; a mark reading process of reading at least one first mark arranged overlapping with an edge of a sheet for adjustment placed on the transparent plate with the reader together with a region outside the sheet for adjustment; an extracting process of extracting at least one edge point on the edge of the sheet for adjustment based on the at least one first mark; and a correcting process of correcting a deviation in the image corresponding to the result of the reading generated in the image generating process based on position information of the at least one edge point extracted in the extracting process.

In each of the reading devices, the reading method, and the medium of the above aspects of the present disclosure, the first mark is arranged overlapping with the edge of the sheet for adjustment. In the mark reading process, the first mark is read together with the region outside the sheet for adjustment, that is, in a so-called minus margin manner. Therefore, the edge point located on a boundary between the sheet for adjustment and the region outside the sheet for adjustment, that is, the position of the edge of the sheet for adjustment can be extracted accurately in the extracting process. As a result, the image corresponding to the result of the reading with the reader can be corrected highly accurately in the correcting process, based on the position information of the edge points on the edge of the sheet for adjustment.

According to the present disclosure, the reading correction with high accuracy can be performed.

### BRIEF DESCRIPTION OF DRAWINGS

FIG. 1 is a schematic diagram illustrating an overall configuration of a multi-function peripheral, which is an embodiment of a reading apparatus of the present disclosure.

FIG. 2 is a block diagram illustrating a control system of the multi-function peripheral.

FIG. 3A illustrates components, disposed around a document scanning unit, in a standard arrangement state, and FIG. 3B illustrates arrangement of image data obtained by scanning performed under the standard arrangement state illustrated in FIG. 3A.

FIG. 4A illustrates components, disposed around the document scanning unit, in a sensor inclined state, and FIG. 4B illustrates arrangement of image data obtained by scanning performed under the sensor inclined state illustrated in FIG. 4A.

FIG. 5A illustrates components, disposed around the document scanning unit, in a document setting plane inclined state, and FIG. 5B illustrates arrangement of image data obtained by scanning performed under the document setting plane inclined state illustrated in FIG. 5A.

FIG. 6A illustrates components, disposed around the document scanning unit, in a document setting plane deviated state, and FIG. 6B illustrates arrangement of image data obtained by scanning performed under the document setting plane deviated state illustrated in FIG. 6A.

FIG. 7 is a diagram illustrating arrangement of an original image data and arrangement of image data after correction by mapping transformation.

FIG. 8 is a diagram for describing reference marks printed on a recording paper and edge points detected based on the reference marks.

FIGS. 9A and 9B are diagrams for describing a method for deriving a straight line of an edge located upstream in a sub-scanning direction, a straight line of an edge located upstream in a main scanning direction, and a document origin, based on position information of the edge points.

FIGS. 10A to 10G are diagrams for describing a determining process for the reference mark and a procedure for detecting the edge point.

FIG. 11 is a diagram illustrating variations of the pattern of the reference mark.

FIGS. 12A to 12C are each a diagram illustrating a variation of arrangement of the reference mark(s).

FIG. 13 is a flowchart illustrating an example of a control procedure of an image data correction process.

FIG. 14 is a flowchart illustrating an example of a control procedure of a mark determining process.

### DESCRIPTION

### Overall Configuration of Multi-Function Peripheral

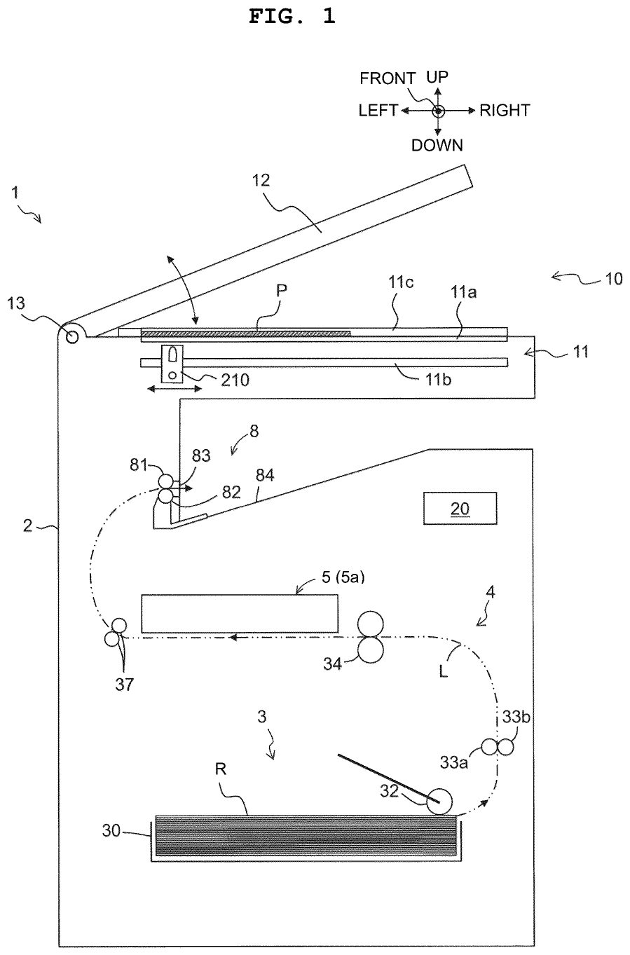

FIG. 1 illustrates an overall configuration of a multi-function peripheral 1 being an embodiment of the reading apparatus of the present disclosure. In FIG. 1, the multi-function peripheral 1 includes a main body 2. A supply unit 3, a conveying unit 4, an image forming unit 5, a discharge unit 8, and a document scanning unit 10 are disposed in the main body 2. The nearside of the paper surface of FIG. 1 corresponds to the front of the multi-function peripheral 1, and the far side of the paper surface of FIG. 1 corresponds to the rear of the multi-function peripheral 1. The side in which the supply unit 3 is disposed in FIG. 1 corresponds to the bottom of the multi-function peripheral 1, and the side in which the document scanning unit 10 is disposed in FIG. 1 corresponds to the top of the multi-function peripheral 1.

### Supply Unit

The supply unit 3 includes a paper feed tray 30 detachably mounted to the lower portion of the main body 2, and a paper feed roller 32. The paper feed tray 30 can accommodate recording papers R being an object of image forming. The paper feed roller 32 is disposed in a manner that the paper feed roller 32 is in contact with an upper surface of the recording paper R at a right portion in the paper feed tray 30. A conveying route L that extends from the paper feed roller 32 to the discharge unit 8 via the conveying unit 4 and the image forming unit 5 is disposed in the multi-function peripheral 1. In a case where the paper feed tray 30 accommodates the recording papers R, the paper feed roller 32 takes out the recording paper R in the paper feed tray 30 one by one, and conveys the recording paper R taken out from the paper feed tray 30 to the conveying unit 4 and the image forming unit 5 along the conveying route L. Note that, although an illustration is omitted, the main body 2 is equipped with a plurality of supplying units 3 each corresponding to one of various paper sizes, and in the paper feed tray 30 of each of the plurality of supply units 3, the recording paper of the corresponding paper size will be placed.

### Conveying Unit

The conveying unit 4 is configured to hold the recording paper R supplied from the supply unit 3 and convey the held recording paper R to the image forming unit 5. The conveying unit 4 includes a conveying roller 33a driven by unillustrated motor and a registration roller 34. The conveying roller 33a is a roller configured to apply a conveying force to the recording paper R. The recording paper R conveyed from the paper feed roller 32 to the conveying roller 33a will be pinched by the conveying roller 33a and a paper dust removing roller 33b, and will be conveyed along the conveying route L toward the registration roller 34. The registration roller 34 is configured to correct the orientation of the recording paper R and then convey the recording paper R to the image forming unit 5.

### Image Forming Unit

The image forming unit 5 performs printing to the recording paper R conveyed from the conveying unit 4. In this example, the image forming unit 5 performs the printing by forming an image in accordance with an inkjet system. The image forming unit 5 includes an ejection head 5a configured to eject ink, and performs printing to the recording paper R with the ink. The recording paper R conveyed from the image forming unit 5 to the conveying roller 37 will be pinched by the conveying roller 37, and will be conveyed along the conveying route L toward the discharge roller 81. Note that the image forming unit 5 is an example of a printing unit. Images may be formed in accordance with systems other than the inkjet system, such as, for example, the known electrophotographic system or thermal transfer system.

### Discharge Unit

The discharge unit 8 is configured to discharge the recording paper R on which the image is formed and which is discharged from the image forming unit 5 to the outside of the multi-function peripheral 1. The discharge unit 8 includes a discharge roller 81, a discharge roller 82, a discharge port 83, and a discharge tray 84. The discharge roller 81 rotates by power from the above-described motor and conveys the recording paper R discharged from the image forming unit 5 toward the discharge tray 84.

### Document Scanning Unit

The document scanning unit 10 includes a flatbed 11 disposed above the main body 2 and a rotatable top plate 12 rotatably disposed above the flatbed 11. The flatbed 11 includes a glass plate 11a extending horizontally along the upper surface of the flatbed 11, and an image sensor 210 movable in the left-right direction along a guide rail 11b at a position immediately below the glass plate 11a. The image sensor 210 is a line image reading sensor extending through the entire of the glass plate 11a in the front-rear direction. The image sensor 210 is configured to move through the entire of the glass plate 11a in the left-right direction, by the driving of, for example, unillustrated motor and feed screw. Owing to such operation, the image sensor 210 can optically read an image on the entire lower surface of the document paper P placed on the upper surface of the glass plate 11a. Hereinafter, the optical reading of the image is referred to as “scanning”.

The rotatable top plate 12 is capable of performing opening and closing movements relative to the flatbed 11 by the rotation of the entirety of the rotatable top plate 12 around a hinge 13 located on the left. The user places the document paper P on the glass plate 11a of the flatbed 11 in a state that the rotatable top plate 12 is opened, and then causes the image sensor 210 to scan the lower surface of the document paper P in a state that the rotatable top plate 12 is closed. Note that the glass plate 11a is an example of a transparent plate, and the image sensor 210 is an example of a reader.

### Control System

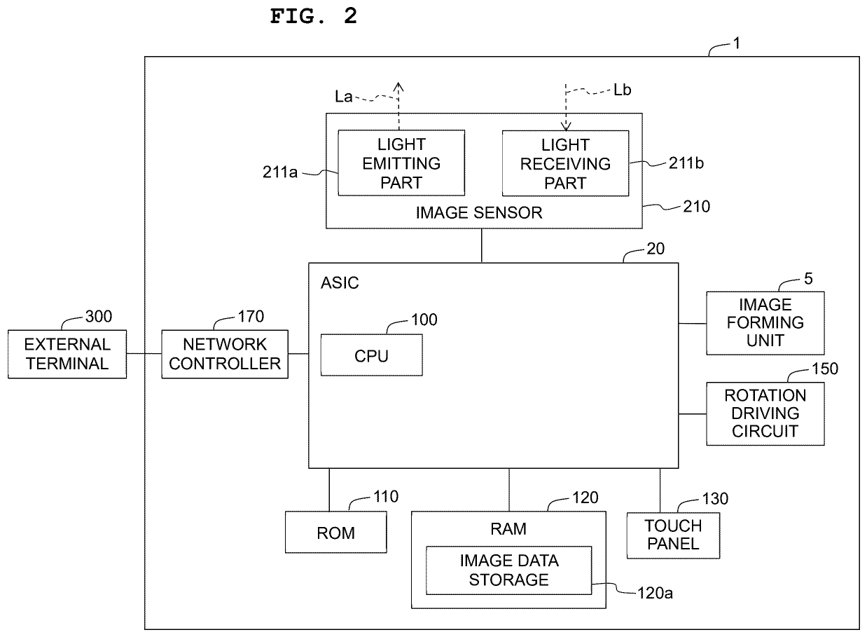

The operation of each part of the multi-function peripheral 1, including the rotation and stop of the above-described motor, is controlled by an ASIC (application specific integrated circuit) 20 that is an integrated circuit for specific application. A block diagram of the control system of the multi-function peripheral 1 including the ASIC 20 is illustrated in FIG. 2. As illustrated in FIG. 2, the ASIC 20 includes a CPU 100. A ROM 110, a RAM 120, a touch panel 130 which is configured to display desired information and which is operable by the user, the image forming unit 5, a rotation driving circuit 150, a network controller 170, and the image sensor 210 are each connected to the ASIC 20. Note that the CPU 100 is an example of a controller.

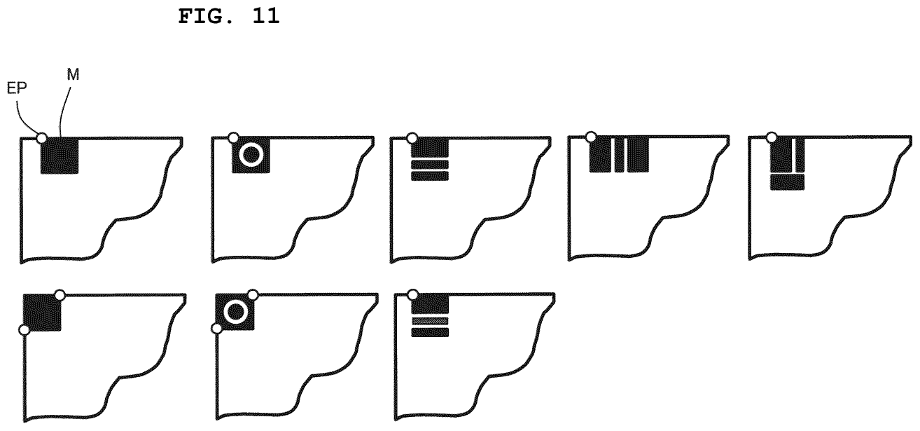

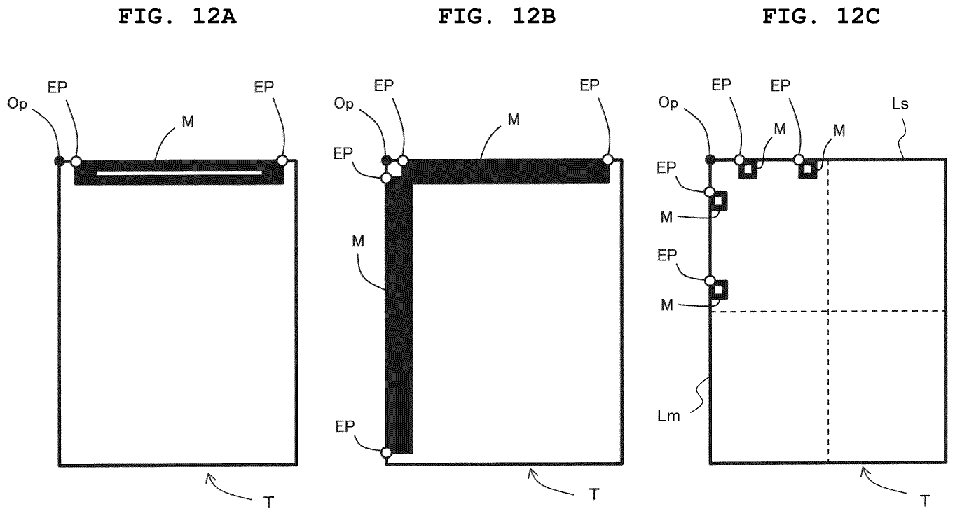

The ROM 110 stores various control programs necessary for the operation of the multi-function peripheral 1, including control programs for performing the procedure illustrated in each of the flowcharts of FIG. 11 and FIG. 12 described below. The CPU 100 controls each part in accordance with the program read out from the ROM 110 and performs the procedure illustrated in each of the flowcharts of FIG. 11 and FIG. 12 described below. An image data storage area 120a, for storing scanned image data obtained by scanning the document paper P with the image sensor 210 and print image data generated by a layout process (that is, an image data correction process) described below, is set in a portion of the storage area of the RAM 120.

The CPU 100 outputs a print instruction signal to the image forming unit 5 via the ASIC 20, thereby instructing the image forming unit 5 to form an image on the recording paper R. The CPU 100 outputs a drive control signal to the rotation driving circuit 150 configured to control the rotation of the above-described motor via the ASIC 20, thereby controlling the rotation of the motor. The CPU 100 controls the network controller 170 via the ASIC 20 to transmit and receive information with respect to an external terminal 300 via wireless or wired network communication.

The image sensor 210 is a reflective type sensor including a light emitting part 211a configured to emit an emitting light La, and a light receiving part 211b capable of receiving a reflected light Lb caused by reflection of the emitting light La emitted from the light emitting part 211a.

### Deviation in Image in Scanning Function and Correction Method Therefor

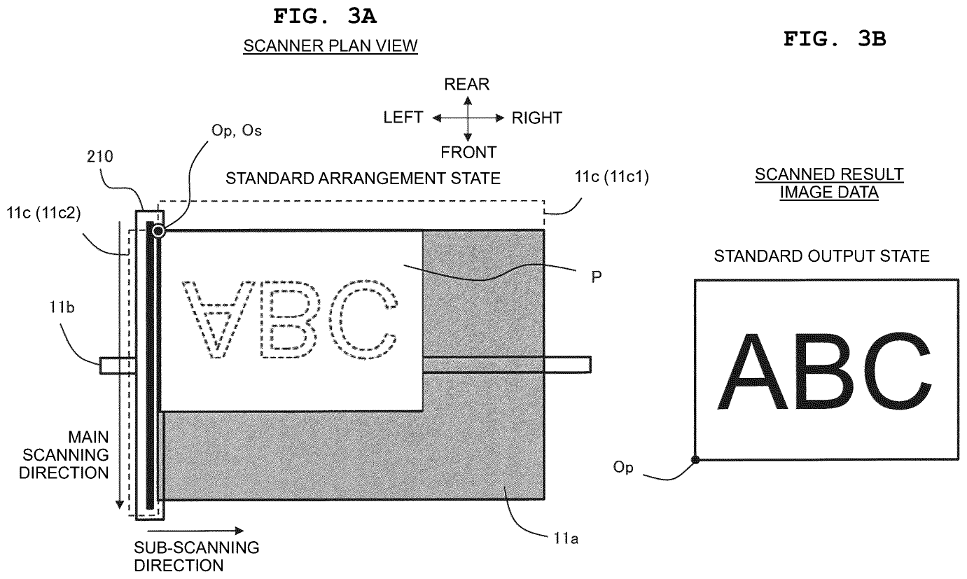

As described above, one of the functions available in the multi-function peripheral 1 having the above configuration is a scanning function. In the scanning function, as described above, a printed surface of the document paper P, which is the object to be read, is placed on the glass plate 11a of the flatbed 11 such that the printed surface abuts the glass plate 11a. Then, under such state, the image sensor 210 will be caused to scan the lower surface of the document paper P. In this situation, in a case where the various components disposed around the document scanning unit 10 are arranged in the standard arrangement state such as illustrated in FIG. 3A, image data generated by the scanning results in data having rectangular shape as a whole and having correct position and correct orientation, such as illustrated in FIG. 3B. Note that in the illustrated example, the print contents on the document paper P is large characters of “ABC” printed at the center of the document paper P.

In FIG. 3A, as described above, the image sensor 210 is the line image reading sensor extending in the front-rear direction across the glass plate 11a. Owing to the moving of the image sensor 210 across the entirety of the glass plate 11a from the left to the right, the image sensor 210 can scan the image on the entire lower surface of the document paper P. In this situation, in a direction of one line for which the scanning by the image sensor 210 can be performed at a time, that is in the extending direction of the line image reading sensor, a direction from the rear to the front will be referred to as a main scanning direction. A direction of the moving of the image sensor 210 from the left to the right will be referred to as a sub-scanning direction.

In the present embodiment, as illustrated in FIG. 1 and illustrated in dashed lines in FIG. 3A, two guide pieces 11c each has sufficient thickness is disposed at the left edge and the rear edge of the glass plate 11a in the flatbed 11. One of the two guide pieces 11c is disposed in parallel with and adjacent to the left edge of the glass plate 11a. The other of the two guide pieces 11c is disposed in parallel with and adjacent to the rear edge of the glass plate 11a. In a case where the user places a rectangular shaped document paper P on the glass plate 11a having a rectangular shape, the user will place the document paper P on the glass plate 11a such that each of two sides orthogonal to each other of the document paper P abuts a side part of one of the two guide pieces 11c. By doing so, the document paper P can be positioned such that one of the four corners of the document paper P coincides with the intersection of the edge located upstream in the main scanning direction and the edge located upstream in the sub-scanning direction of the glass plate 11a, and each of the four sides of the document paper P is in parallel with the main scanning direction or the sub-scanning direction. Under such placement state, the top of the corner of the document paper P that coincides with the intersection of the right surface of the guide piece 11c located along the left edge of the glass plate 11a and the front surface of the guide piece 11c located along the rear edge of the glass plate 11a will be referred to as a document origin Op. A point, on the image data generated by the scanning performed under the standard arrangement state such as illustrated in FIG. 3A, corresponding to the document origin Op will be referred to as a scanning origin Os. The user can freely choose to place the document paper P vertically or horizontally. The guide piece 11c is an example of a contact part.

Then, the image sensor 210 can obtain scanned image data formed to have a rectangular shape in a correct position and a correct orientation as illustrated in FIG. 3B, by performing trimming of data obtained by scanning the entire of the glass plate 11a and the region around and adjacent to the glass plate 11a so that an image of a region in which the document paper P exists is solely extracted. In such a manner, in the present embodiment, the scanning line of the image sensor 210 has a dimension slightly larger than the entire dimension of the glass plate 11a in the front-rear direction, and the scanning line of the image sensor 210 moves over a range slightly larger than the dimension of the glass plate 11a in the left-right direction. In the following, the scanning such as described above performed so as to scan a region slightly larger than an existing region in which the document paper P as a scanning object exists, that is performed so as to scan the region including the existing region and a region outside the existing region, will be referred to as minus margin scanning. Note that, a series of processes including the above scanning and the generating of the scanned image data is an example of an image generating process and an image generating step.

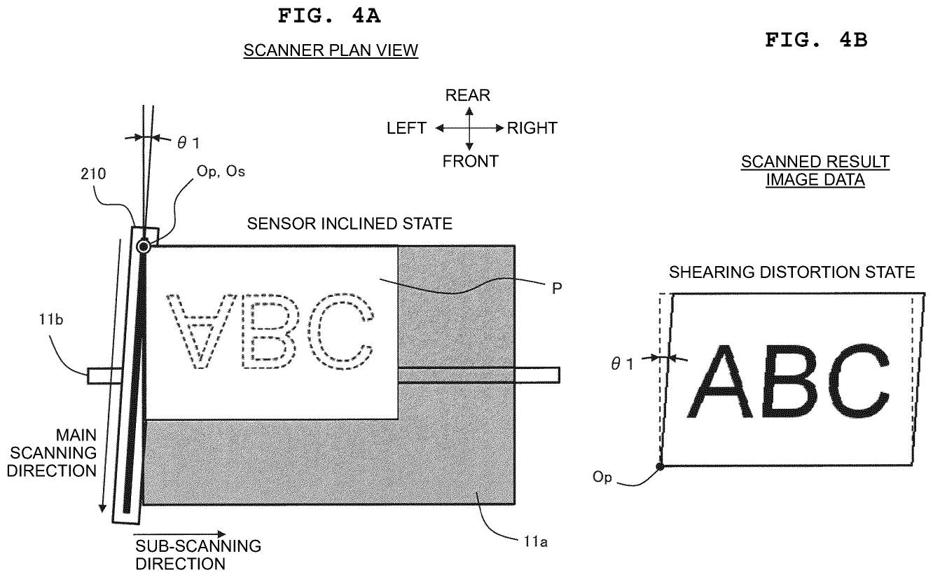

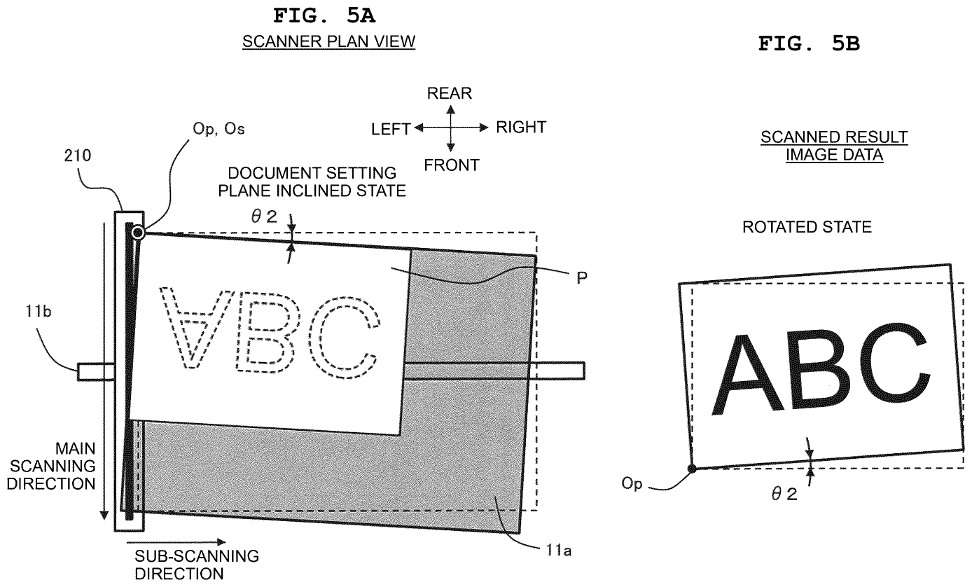

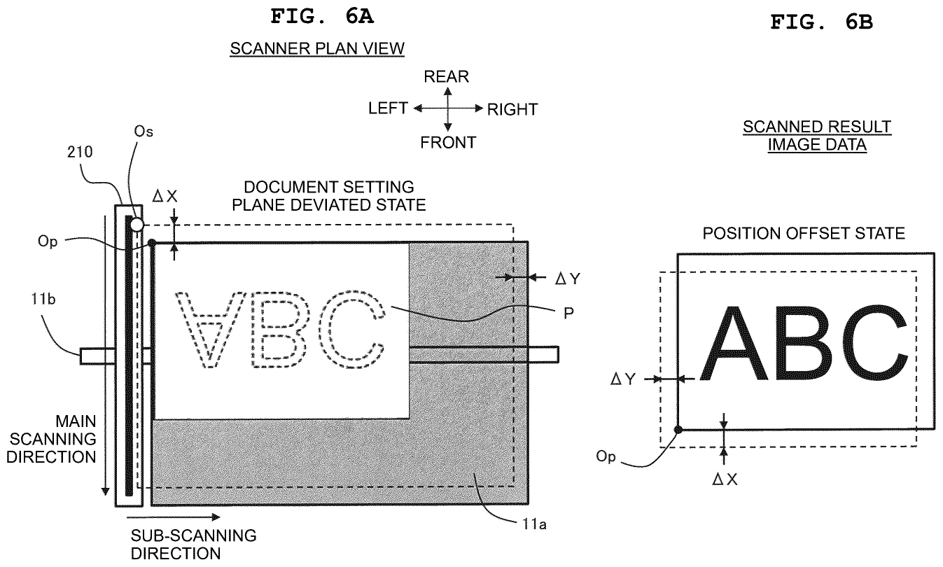

As described above, in the standard arrangement state in which the components of the document scanning unit 10 are arranged as originally designed, the image data generated by the scanning has a correct position, a correct orientation, and a correct rectangular shape. However, in a case where the multi-function peripheral 1 has been used for a long time, an error occurs in the positional relationship between the components of the document scanning unit 10 due to degradation over time or an accidental event. As a result, deviations or distortions will be occurred in data contents of the image data generated by the scanning. Specifically, error states that can occur in the positional relationship between the components mainly includes, a sensor inclined state illustrated in FIG. 4A, a document setting plane inclined state illustrated in FIG. 5A, and a document setting plane deviated state illustrated in FIG. 6A, those can occur independently or in combination. In a case where the document paper P is scanned under the condition that at least one of the error states is realized, the data error(s) corresponding to the error state(s) realized occur(s) in the image data independently or in combination.

In the sensor inclined state illustrated in FIG. 4A, an error occurs in the following manner. That is, the extending direction of the image sensor 210 originally designed to be in parallel with the main scanning direction is inclined with respect to the main scanning direction at the angle of θ1 (hereinafter, referred to as a “sensor inclination angle θ1”). In this case, the image sensor 210 performs the scanning by moving in parallel with and along the sub-scanning direction while maintaining the posture inclined at the sensor inclination θ1 with respect to the main scanning direction. Thus, the image data generated by the scanning will be in a shearing distortion state in which the image is distorted in a shearing manner at the sensor inclination angle θ1 as illustrated in FIG. 4B.

In the document setting plane inclined state illustrated in FIG. 5A, an error occurs in the following manner. That is, the glass plate 11a originally designed to have each edge being in parallel with or orthogonal to the main scanning direction is inclined with respect to the originally designed state at an angle of θ2 (hereinafter, referred to as a “document setting plane inclination angle θ2”). In this case, the entire of the image data generated by the scanning will be in a rotated state in which the image is rotated around the document origin Op at the document setting plane inclination angle θ2 as illustrated in FIG. 5B.

In the document setting plane deviated state illustrated in FIG. 6A, an error occurs in the following manner. That is, although the document origin Op on the document paper P and the scanning origin Os on the scanned data are originally designed to be identical to each other, the document origin Op and the scanning origin Os offsets from each other by the distance ΔX in the main scanning direction and by the distance ΔY in the sub-scanning direction, owing to the positional deviation of at least one of the glass plate 11a and the guide piece 11c. In this case, the image data generated by the scanning will be in a positional offset state in which the image offsets by the distance ΔX in the main scanning direction and by the distance ΔY in the sub-scanning direction, as illustrated in FIG. 6B.

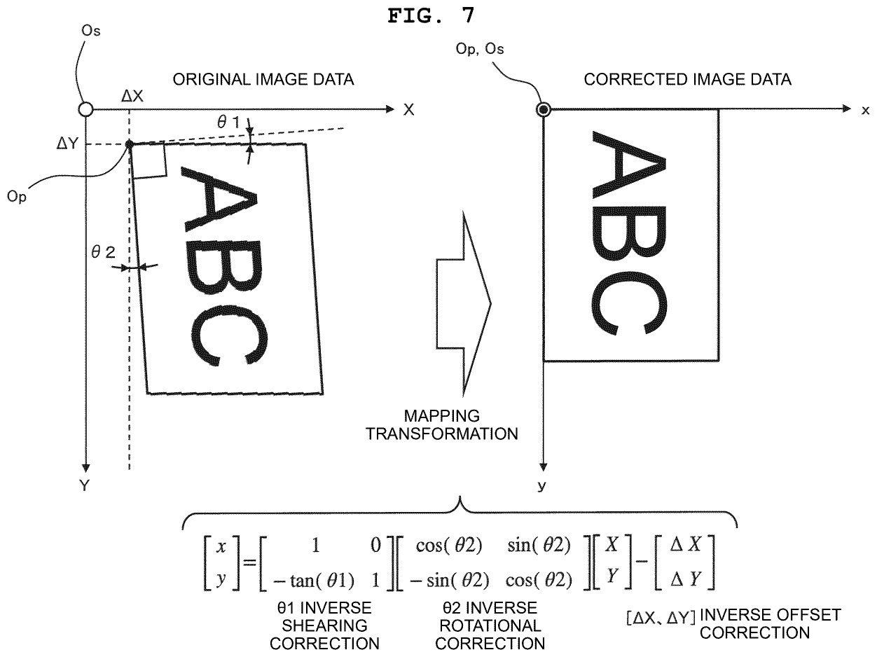

For example, in a case where the three error states described above are realized simultaneously, the image data in which the deviation and the distortion corresponding respectively to the error states occur in combination as illustrated in the left of FIG. 7 will be obtained. In view of such situation, in the present embodiment, data correction will be performed on the original image data obtained by the scanning in accordance with a software processing, thereby generating the scanned image data with the correct position and the correct orientation and formed to have the rectangular shape, as illustrated in the right of FIG. 7, that should had been obtained by the scanning if none of the error states was realized. The contents of the correction method includes a process of moving each pixel in the original image data by mapping transformation corresponding to each of the error states. As a specific contents of the mapping transformation, a transformation matrix of the Determinant (1) below for performing rotational correction of rotating the image inversely at the document setting plane inclination angle θ2, a transformation matrix of the Determinant (2) below for performing shearing correction in the inverse direction at the sensor inclination angle θ1, and then a transformation matrix of the Determinant (3) below for performing offset correction in the inverse direction by the distance ΔX in the main scanning direction and by the distance ΔY in the sub-scanning direction will be applied to the coordinate system [X, Y] of the original image in this order to mapping transform the coordinate system [X, Y] to the corrected coordinate system [x, y].

$$[ \begin{matrix}cos ( θ2 ) & sin ( θ2 ) \\ - sin θ 2 & cos ( θ2 )\end{matrix} ] \qquad determinant ( 1 )$$

$$[ \begin{matrix}1 & 0 \\ - tan ( θ 2 ) & 1\end{matrix} ] \qquad determinant ( 2 )$$

$$- [ \begin{matrix}Δ X \\ Δ Y\end{matrix} ] \qquad determinant ( 3 )$$

### Derivation of Error Parameter and Reference Mark

As described above, in order to correct the error in the image data appropriately, performing appropriate detection of error parameters including the sensor inclination angle θ1, the document setting plane inclination angle θ2, and the distances ΔX and ΔY (hereinafter, referred to collectively as a document setting plane offset amount [ΔX, ΔY]) is preferable. In adjustment performed in a manufacturing factory of the multi-function peripheral 1 prior to the shipment, the error parameters of errors caused, for example, by the assembly error can be detected by using a chart jig on which various reference patterns are marked, and based on the contents of the data obtained by scanning the reference patterns. The chart jig is a thin plate of, for example, aluminum suffering less dimension change over time. Meanwhile, in a case where a repair worker performs adjustment of the multi-function peripheral 1 at the site where the multi-function peripheral 1 is actually used, bringing such chart jig into the site to use for the adjustment is not practical.

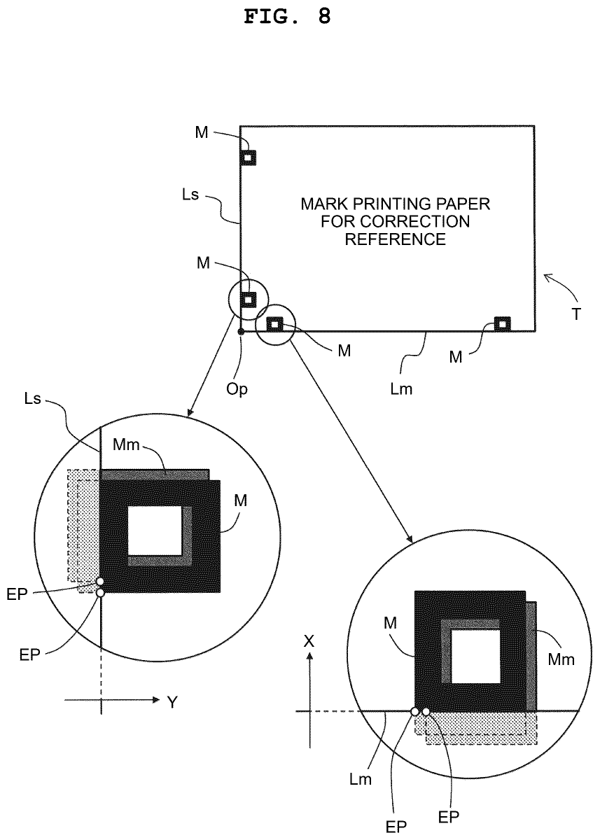

In view of the above situation, in the present embodiment, degree of straightness of each of four edges and degrees of orthogonality and parallelization between two of the four edges of the recording papers R generally distributed and used are regarded as being reliable to some extent, and the image of the reference mark M such as illustrated in FIG. 8 will be printed on the recording paper R by the image forming unit 5. Then, the recording paper R on which the reference mark M has been printed will be scanned as the sheet for adjustment T by the document scanning unit 10, instead of the chart jig described above, and the various error parameters described above will be detected based on the image data obtained by the scanning.

In the example illustrated in FIG. 8, the reference mark M is printed at four positions including a position close to one end and a position close to the other end of each of the edge located upstream in the main scanning direction and the edge located upstream in the sub-scanning direction of the sheet for adjustment T. Here, the edge located upstream in the main scanning direction or the sub-scanning direction of the sheet for adjustment T means the edge located upstream in the main scanning direction or the sub-scanning direction of the sheet for adjustment T placed on the glass plate 11a. In the following, the position of the edge of the sheet for adjustment T will be described based on the state where the sheet for adjustment T is placed on the glass plate 11a. The reference mark M of the example illustrated in FIG. 8 has display contents in which white rectangular shape is arranged at the center of a black rectangular shape. Each of the reference marks M is printed such that one side of the black rectangular shape of the reference mark M is arranged overlapping with one of the above edges of the sheet for adjustment T, that is one of the edge Lm located upstream in the main scanning direction and the edge Ls located upstream in the sub-scanning direction. Thus, one side of each of the reference marks M deviates from the sheet for adjustment T and is not printed, and the side of the printed part of the reference mark M is printed in black on the edge of the sheet for adjustment T assuredly.

Thus, in the image data obtained by scanning the reference mark M, any point detected on the side of the printed part of the reference mark M can be regarded as a point positioned on the edge of the sheet for adjustment T. Even in the reference mark Mm printed at somewhat deviated position due to low print arrangement accuracy of the image forming unit 5, any point detected on the side of the printed part of the reference mark Mm can be regarded as positioning on the edge of the sheet for adjustment T. That is, low accuracy of the print arrangement of the image forming unit 5 is permitted and an edge point EP on the edge of the sheet for adjustment T is detected assuredly.

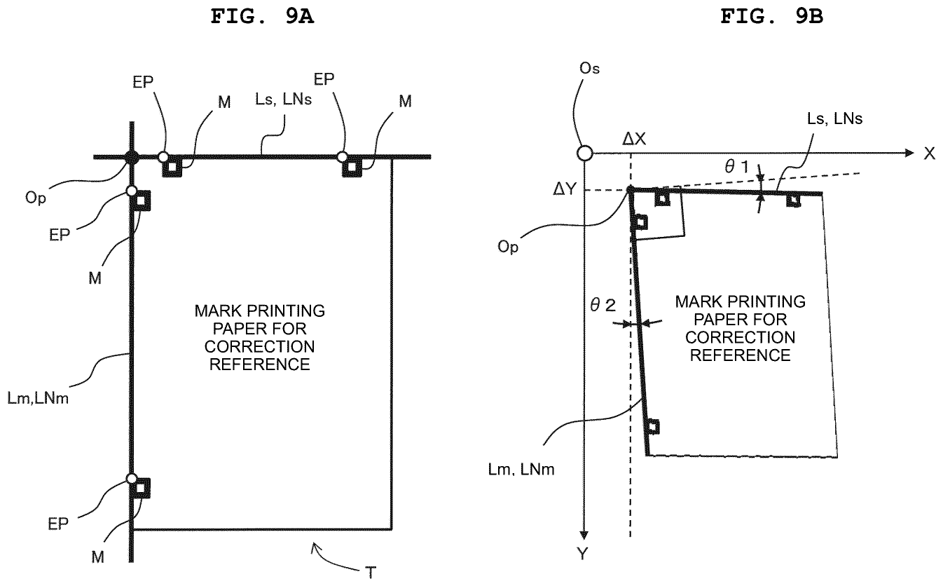

The edge point EP will be detected from each of the four reference marks M printed as described above, and straight lines LNm and LNs each extending through the edge points EP of two reference marks M overlapping with identical edge will be drawn, as illustrated in FIG. 9A. The arrangement of the straight line LNm is coincident with the arrangement of the actual edge Lm located upstream in the main scanning direction of the sheet for adjustment T, and the arrangement of the straight line LNs is coincident with the arrangement of the actual edge Ls located upstream in the sub-scanning direction of the sheet for adjustment T. The intersection of the straight line LNm and the straight line LNs is coincident with the document origin Op. Therefore, on the coordinate of the image data obtained by scanning the sheet for adjustment T, as illustrated in FIG. 9B, the angle between the sub-scanning direction axis extending along the Y axis direction of FIG. 9B and the edge Lm located upstream in the main scanning direction corresponds to the document setting plane inclination angle θ2; the angle between a direction axis orthogonal to the edge Lm located upstream in the main scanning direction and the edge Ls located upstream in the sub-scanning direction corresponds to the sensor inclination angle θ1; and an offset amount of the document origin Op relative to the scanning origin Os corresponds to the document setting plane offset amount [ΔX, ΔY]. The calculation of the sensor inclination angle θ1 and the document setting plane inclination angle θ2 may be achieved by, for example, using known calculation method in accordance with an inverse trigonometric function etc., and the details therefor will be omitted here.

As described above, based on the scanned image data of the sheet for adjustment T on which the reference mark M is printed, each of the error parameters of the document scanning unit 10 inherent at the timing can be derived. Note that, the edge Ls located upstream in the sub-scanning direction of the sheet for adjustment T is an example of a first edge and an objective edge; the edge point EP on the edge Ls located upstream in the sub-scanning direction is an example of a first edge point and an objective edge point; the edge Lm located upstream in the main scanning direction of the sheet for adjustment T is an example of a second edge and an objective edge; the edge point EP on the edge Lm located upstream in the main scanning direction is an example of a second edge point and an objective edge point; the reference mark M is an example of a first mark; the straight line LNm coincident with the arrangement of the edge Lm located upstream in the main scanning direction is an example of a first straight line; and the straight line LNs coincident with the arrangement of the edge Ls located upstream in the sub-scanning direction is an example of a second straight line.

### Determining Process for Reference Mark and Detecting Method for Edge Point

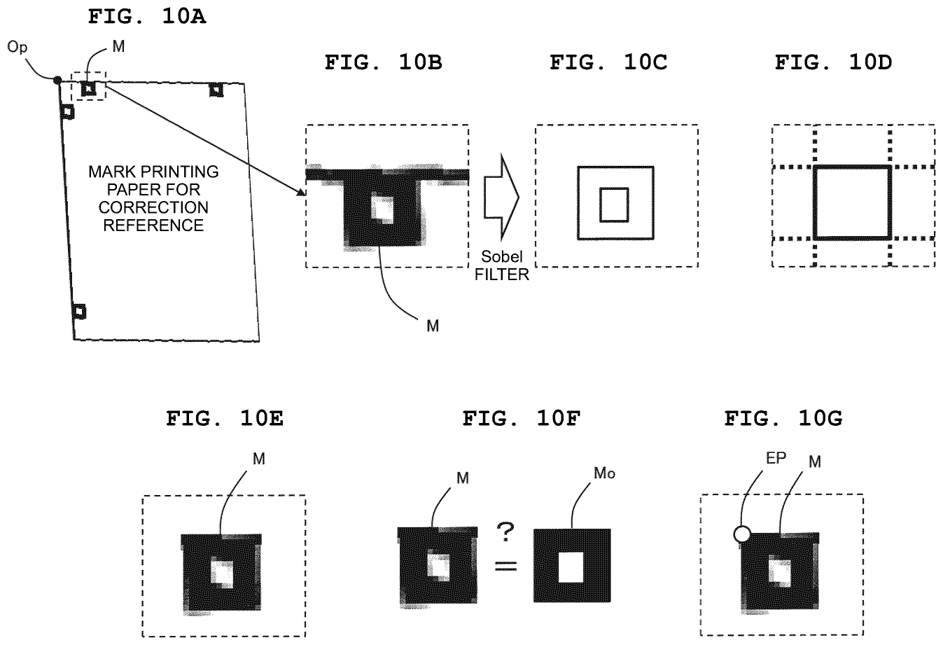

A process of determining whether the reference mark M exists in the scanned image data of the sheet for adjustment T will be described. FIG. 10 illustrates a procedure of the determining process for the reference mark M. First, as illustrated in FIG. 10A, somewhat wide prescribed region within which the reference mark M is expected to exist is extracted from the scanned image data of the sheet for adjustment T, and the data of the prescribed region is obtained with local coordinate position information of the prescribed region. Then, a filtering process is performed to a partial image data of the reference mark M such as illustrated in the FIG. 10B by Sobel filter for so called edge enhancement so as to extract an edge of a candidate image for the reference mark M as illustrated in FIG. 10C.

Then, four straight lines each tangential to the outline of the candidate image for the reference mark M are derived, and a mask pattern of a region surrounded by the four straight lines is generated as illustrated in FIG. 10D. By performing bit masking of the partial image data illustrated in FIG. 10B with the mask pattern, a candidate portion for the reference mark M can be solely extracted as illustrated in FIG. 10E. By comparing the candidate portion for the reference mark M with a dot pattern of a predetermined reference mark Mo in accordance with, for example, the method of so-called pattern matching as illustrated in FIG. 10F, whether the candidate portion is the proper reference mark M can be determined. Note that, the predetermined reference mark Mo is an example of a predetermined mark.

In a case where the candidate portion is determined to be the reference mark M, the edge point EP on the side corresponding to the edge Lm or the edge Ls of the sheet for adjustment T is detected as illustrated in FIG. 10G, and the position of the edge point EP is obtained together with the local coordinate position information. Note that if the edge point EP is detected at one of the ends of the side, the accuracy of detection of the edge point EP increases.

Note that, a pattern of the reference mark M is not limited to the black rectangular shape within which the white rectangular shape is positioned, and may be various patterns, for example, such as illustrated in FIG. 11. Although specific illustration is omitted, for example, in a case where the area of the reference mark M is small like a dot, the reference mark M may not be distinguished from the black dot mistakenly printed on the sheet for adjustment T or the image of the dust mixed onto the sheet for adjustment T during the scanning. Thus, the reference mark M may be a pattern having an area larger than a predetermined size. In a case where the pattern of the reference mark M has a simple black rectangular shape, the pattern may not be distinguished from any pattern present as a background on the sheet for adjustment T. Thus, the pattern of the reference mark M may be a pattern as characteristic as possible.

A plurality of edge points EP may be detected from one reference mark M. If the plurality of edge points EP detected from the identical edge, that is the edge Lm or the edge Ls, are distant from each other, the straight line LNm or the straight line LNs extending through the edge points EP is more likely to match the edge Lm or the edge Ls. Thus, one reference mark M may be printed in elongated manner along the scanning direction, and the plurality of edge points EP may be detected at both ends of the identical side of the one reference mark M or at positions distant from each other on the identical side of the one reference mark M, as illustrated in FIG. 12A.

If the entirety of the reference mark M has a characteristic pattern and easily distinguishable, the reference mark M positioned at the edge Lm located upstream in the main scanning direction and the reference mark M positioned at the edge Ls located upstream in the sub-scanning direction may be printed continuously, as illustrated in FIG. 12B.

Among the plurality of edge points EP detected from identical edge being the edge Lm or the edge Ls, the edge point EP close to the document origin Op is regarded as having higher reliability regarding the accuracy of the detected position. Thus, as illustrated in FIG. 12C, the plurality of edge points EP may be detected at the upstream of the middle point dividing the edge Lm or the edge Ls equally, that is at the region between the document origin Op and the middle point. Note that the region between the middle point and the document origin Op is an example of a first region and the region opposite to the document origin Op with respect to the middle point is an example of a second region.

### Control Procedure

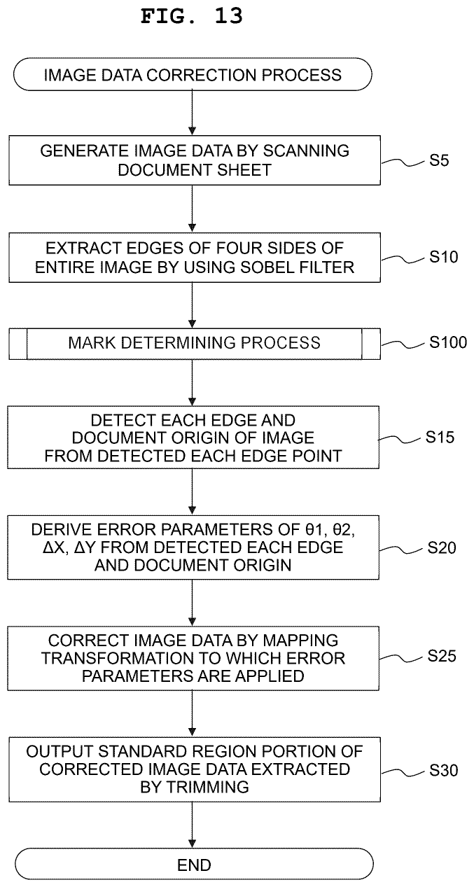

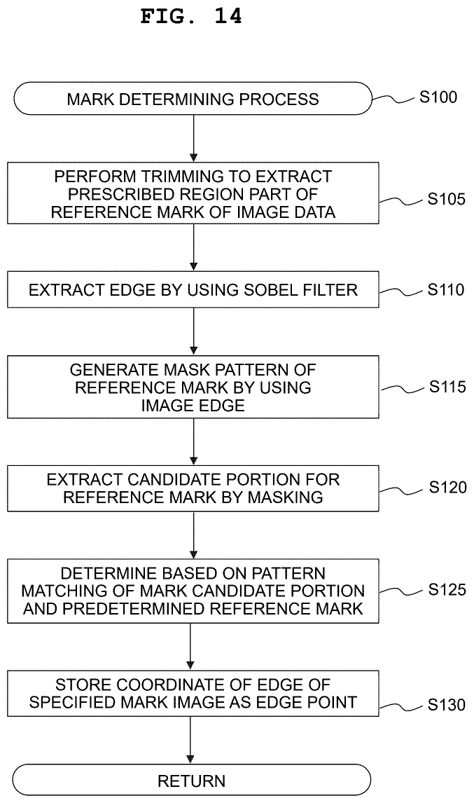

As an example for implementing the above method, a control procedure performed by the CPU 100 will be described with reference to the flowcharts in FIG. 13 and FIG. 14. Before performing this control procedure, an user prepares the sheet for adjustment T with reference mark M printed thereon in advance, and sets the sheet for adjustment T on the glass plate 11a in a manner that the sheet for adjustment T is adjacent to the sides of the two guide pieces 11c of the document scanning unit 10. In this state, in a case where the user presses an unillustrated start button, performing of the flow in FIG. 13 will be started.

First, in a step S5, the CPU 100 causes the image sensor 210 to perform the minus margin scanning of the sheet for adjustment T so as to generate an image data. In the minus margin scanning, the image sensor 210 images the sheet for adjustment T along the main scanning direction while moving in the sub-scanning direction.

Then, in a step S10, the CPU 100 extracts four edges constituting the entire outline of the image data, by the filtering process using the Sobel filter.

Then, in a step S100, the CPU 100 performs the mark determining process described above with reference to FIG. 10 so as to determine whether the reference mark M exists in the image data and detect the edge points EP.

Then, in the step S15, the CPU 100 detects the edge Ls located upstream in the sub-scanning direction, the edge Lm located upstream in the main scanning direction, and the document origin Op in the image data, based on the detected edge points EP.

Then, in a step S20, the CPU 100 derives the error parameters that is, the sensor inclination angle θ1, the document setting plane inclination angle θ2, and the distance ΔX, and the distance ΔY, based on the edge Lm, the edge Ls, and the document origin Op detected in the step S15.

Then, in a step S25, the CPU 100 corrects the original image data obtained by the scanning, by the mapping transformation in which the error parameters derived in the step S20 is applied.

Then, in a step S30, the CPU 100 performs trimming to extract a standard region portion from the corrected image data, and output the standard region portion extracted by the trimming. Then, the CPU 100 terminates the flow.

Detailed control procedure of the mark determining process of the step S100 illustrated in FIG. 14 will be described next. Note that, the mark determining process corresponds to the procedure described above with reference to FIG. 10.

First, in a step S105, the CPU 100 performs trimming so as to extract somewhat large prescribed region within which the reference mark M is expected to exist from the scanned image data of the sheet for adjustment T, and obtains the data of the prescribed region together with the local coordinate position information of the prescribed region.

Then, in a step S110, the CPU 100 performs filtering process to the partial image data including the reference mark M by using the Sobel filter for so called edge enhancement so as to extract the edge of the reference mark M.

Then, in a step S115, the CPU 100 derives four straight lines each tangential to the outline of the candidate portion for the reference mark, and generates the mask pattern of the region surrounded by the four straight lines.

Then, in a step S120, the CPU 100 solely extracts the candidate portion for the reference mark M by performing masking with the mask pattern.

Then, in a step S125, the CPU 100 determines whether the extracted part is the proper reference mark M, by comparing the extracted candidate portion for the reference mark M with the dot pattern of the predetermined reference mark Mo by, for example, the method of so-called pattern matching. Note that, although specific illustration is omitted, in a case where the CPU 100 determines that the candidate portion is not the reference mark M, the CPU 100 performs predetermined error notification and then terminates the image data correction process.

On the other hand, in a case where the CPU 100 determines that the candidate portion is the reference mark M, then the CPU 100 detects the edge points EP on the side of the specified reference mark M in a step S130, and obtains the positions of the edge points EP together with the local coordinate position information described above. After that, the CPU 100 terminates the flow.

Note that, the control procedure described above is the procedure performed in the adjustment operation performed at the site where the multi-function peripheral 1 is used, and the process of scanning the sheet for adjustment T with the reference mark M printed thereon so as to derive the error parameters is also performed as a part of the procedure. Meanwhile, in normal usage in which an user scans any document paper P prepared as the reading object, the step S10, the step S100, the step S15 and the step S20 may be omitted, and the correction process of the step S25 and the step S30 in which the error parameters derived most recently is applied may be performed after the performing of the step S5.

In the above description, the procedure in the step S5 is an example of a mark reading process and a mark reading step, a procedure in the step S125 is an example of a determining process and a determining step, a procedure in the step S130 is an example of an extracting process and an extracting step, and the procedure in the step S25 is an example of a correction process and a correction step.

### Effect of Embodiment

As described above, in the multi-function peripheral 1 of the present embodiment, the reference mark M is arranged to overlap with the edge Lm or the edge Ls of the sheet for adjustment T. In the procedure of the step S5, the reference mark M is read including the region outside the sheet, that is in an aspect of so called the minus margin. Thus, in a case where the CPU 100 determines that the reference mark M is equivalent to the predetermined reference mark Mo, the CPU 100 can correctly extract the edge points EP on the boundary between the sheet for adjustment T and the region outside the sheet, that is the positions of the edges Lm and Ls of the sheet for adjustment T, in the procedure of the step S130. As a result, in the procedure of the step S15, the CPU 100 can correct the image data corresponding to the scanning result with high accuracy, based on the position information of the edge points EP on the edges Lm and Ls of the sheet for adjustment T.

Note that, each of the reference marks M illustrated so far is arranged on the edge Lm or Ls at a position somewhat separated from the document origin Op of the sheet for adjustment T. However, the reference mark M may be arranged to overlap with the document origin Op of the sheet for adjustment T so as to overlap with both of the edge Lm and the edge Ls (not illustrated). In this case, the edge point EP on the edge Lm and the edge point EP on the edge Ls can be detected based on the identical reference mark M. The edge point EP may be detected at any position, that is at the right end or the left end of the side of the mark or at the center of the side of the mark.

The present embodiment includes the following feature. That is, in the procedure of the step S130, the CPU 100 extracts two edge points EP on one edge Lm or one edge Ls of the edges Lm and Ls of the sheet for adjustment T. In the present embodiment, the CPU 100 can obtain the position information of one edge Lm or one edge Ls of the sheet for adjustment T based on the extracted two edge points EP. The CPU 100 can perform the correction highly accurately based on the position information of the one edge Lm or the one edge Ls. Owing to the extracting of the two edge points EP as described above, the CPU 100 can draw the straight line LNm or the straight line LNs at the edge Lm or the edge Ls of the sheet for adjustment T. In a case where the straight line LNm or the straight line LNs is inclined, the CPU 100 can determine that the correction is required. Note that, the CPU 100 may extract one edge point EP from each of the two reference marks M, or may extract two edge points EP from one reference mark M.

The present embodiment includes the following feature. That is, in the procedure of the step S130, the CPU 100 extracts two edge points EP on the edge Ls located upstream in the sub-scanning direction among the plurality of edges Lm and Ls. The CPU 100 can obtain the position information of the edge Ls located upstream in the sub-scanning direction of the sheet for adjustment T extending along the main scanning direction. The edge Ls located upstream in the sub-scanning direction should be in parallel with the main scanning direction of the image sensor 210 in the standard arrangement state. Thus, whether the image sensor 210 is inclined can be determined based on the position information of the edge Ls located upstream in the sub-scanning direction.

The present embodiment includes the following feature. That is, in the procedure of the step S25, the CPU 100 corrects the shearing deviation of the image data obtained by the scanning, based on the position information of the two edge points EP on the edge Ls located upstream in the sub-scanning direction extracted in the procedure of the step S130. Thus, the CPU 100 can correct the shearing deviation of the image data caused due to the inclination of the image sensor 210 highly accurately.

The present embodiment includes the following feature. That is, in the procedure of the step S130, the CPU 100 extracts two edge points EP on the edge Ls located upstream in the sub-scanning direction and two edge points EP on the edge Lm located upstream in the main scanning direction, among the plurality of edges Lm and Ls. The CPU 100 can obtain the position information of the edge Ls located upstream in the sub-scanning direction and the edge Lm located upstream in the main scanning direction of the sheet for adjustment T based on the result of the extracting. Since the CPU 100 can determine the inclinations of both of the edge Ls located upstream in the sub-scanning direction and the edge Lm located upstream in the main scanning direction of the sheet for adjustment T, the CPU 100 can perform the correction further highly accurately.

Note that the CPU 100 can determine both of the sensor inclination angle θ1 of the image sensor 210 and the document setting plane inclination angle θ2 of the document setting plane based on the inclinations of the edge Ls located upstream in the sub-scanning direction and the inclination of the edge Lm located upstream in the main scanning direction, and can calculate an aspect of the correction required. The CPU 100 may extract one edge point EP from each of the plurality of reference marks M or may extract a plurality of edge points EP from one reference mark M.

The present embodiment includes the following feature. That is, in the procedure of the step S25, the CPU 100 corrects the rotational deviation of the image data obtained by the scanning, based on the position information of the two edge points EP on the edge Ls located upstream in the sub-scanning direction and the two edge points EP on the edge Lm located upstream in the main scanning direction extracted in the procedure of the step S130. Thus, the CPU 100 can correct the rotational deviation of the image data highly accurately.

The present embodiment includes the following feature. That is, in the procedure of the step S25, the CPU 100 corrects the shearing deviation after correcting the rotational deviation of the image data obtained by the scanning. Thus, even in a case where the rotational deviation and the shearing deviation have been occurred in combination, the CPU 100 can derive the error parameter of the sensor inclination angle θ1 highly accurately with simple procedure, and can correct the shearing deviation appropriately.

The present embodiment includes the following feature. That is, the multi-function peripheral 1 further includes the guide piece 11c to be used for performing positioning in a case where the document paper P and the sheet for adjustment T as the reading objective are placed on the glass plate 11a. The guide piece 11c includes the first guide piece lidl located upstream in the main scanning direction of the glass plate 11a and the second guide piece 11c2 located upstream in the sub-scanning direction of the glass plate 11a. In the procedure of the step S130, the CPU 100 uses one of the two edge points EP on the edge Ls located upstream in the sub-scanning direction closer to the guide piece 11c1 than the other, and one of the two edge points EP on the edge Lm located upstream in the main scanning direction closer to the guide piece 11c2 than the other. Thus, the CPU 100 can perform reading correction more assuredly and highly accurately.

The present embodiment includes the following feature. That is, in the procedure of the step S130, the CPU 100 extracts at least one edge point EP on the edge Ls located upstream in the sub-scanning direction of the edges Lm and Ls of the sheet for adjustment T. Further, in the procedure of the step S25, the CPU 100 correct the deviation in the sub-scanning direction of the image data, based on the position information of the at least one edge point EP extracted in the step S130. Thus, the CPU 100 can perform reading correction highly accurately.

The present embodiment includes the following feature. That is, in the procedure of the step S130, the CPU 100 extracts two edge points EP on the edge Ls located upstream in the sub-scanning direction of the edges Lm and Ls, and can obtain the two pieces of the position information of the edge Ls located upstream in the sub-scanning direction corresponding to the result of the extracting. Further, in the procedure of the step S25, the CPU 100 corrects the deviation caused due to the shearing distortion of the image data depending on the magnitude of the sensor inclination angle θ1 calculated based on the two pieces of the position information on the edge Ls located upstream in the sub-scanning direction obtained in the step S130. Thus, the CPU 100 can perform the reading correction assuredly and highly accurately. Note that, although the illustration is omitted, the two edge points may be located equally in the front-rear direction such that a distance between one of the two edge points and one end of the edge Ls and a distance between the other of the two edge points and the other end of the edge Ls is identical to each other. Alternatively, the distance between one of the two edge points and the one end of the edge Ls and the distance between the other of the two edge points and the other end of the edge Ls may be different from each other. The CPU 100 may perform position correction by using an average of the positions in the sub-scanning direction of the two edge points EP, and may perform the position correction by using a weighted mean (one of the two positions in the sub-scanning direction closer to the document origin Op than the other of the two positions will be weighted more largely than the other of the two positions.).

The present embodiment includes the following feature. That is, in the procedure of the step S130, the CPU 100 extracts at least one edge point EP on the edge Lm located upstream in the main scanning direction of the edges Lm and Ls of the sheet for adjustment T. Further in the procedure of the step S25, the CPU 100 corrects the deviation in the main scanning direction of the image data, based on the position information of the at least one edge point EP extracted in the step S130. Thus, the CPU 100 can perform the reading correction assuredly and highly accurately.

The present embodiment includes the following feature. That is, in the procedure of the step S130, the CPU 100 extracts at least one edge point EP on the reference mark M, which is determined as the predetermined reference mark Mo in the step S125 and which is located in the region being one region, of the two regions obtained by dividing the sheet for adjustment T along the sub-scanning direction, closer to the document origin Op than the other region of the two regions. Then, in the procedure of the step S25, the CPU 100 corrects the deviation in the main scanning direction of the image data, based on the position information of the at least one edge point EP extracted in the step S130.

The sheet for adjustment T being rectangular may be arranged such that the long sides of the sheet for adjustment T extend along the sub-scanning direction and the short sides of the sheet extend along the main scanning direction. In such a case, the CPU 100 extracts two edge points EP on the edge Lm located upstream in the main scanning direction in the procedure of the step S130, and corrects the deviation in the main scanning direction of the image by using the position information of the two edge points EP in the procedure of the step S25.

Here, the position of the document origin Op which serves as the basis for various position detecting and position calculating regarding the document scanning unit 10 is generally set on one side of the glass plate 11a in the main scanning direction, that is for example upstream of the glass plate 11a in the main scanning direction. Thus, in a case where the CPU 100 performs the correction of the deviation in the main scanning direction of the image described above, a case in which the reference mark M in the region closer to the document origin Op in the main scanning direction is used can realize higher accuracy as compared to a case in which the reference mark M in the region farther from the document origin Op in the main scanning direction is used.

In the present embodiment, in view of the above situation, the CPU 100 extracts the edge point EP on the reference mark M located in the region closer to the document origin Op of the sheet for adjustment T in the step S130, and the CPU 100 perform the correction by using the position information of the edge point EP in the step S25. Thus, the CPU 100 can perform the reading correction more assuredly and highly accurately.

The present embodiment includes the following feature. That is, in the procedure of the step S130, the CPU 100 extracts the two edge points EP on the edge Ls located upstream in the sub-scanning direction and the two edge points EP on the edge Lm located upstream in the main scanning direction of the plurality of edges. Further, in the procedure of the step S25, the CPU 100 corrects the deviation of the image data in at least one of the sub-scanning direction and the main scanning direction, based on the position information of the intersection of the straight line LNs connecting two edge points EP on the edge Ls located upstream in the sub-scanning direction and the straight line LNm connecting two edge points EP on the edge Lm located upstream in the main scanning direction. That is, the CPU 100 can calculate the offset amount of the sheet for adjustment T placed on the glass plate 11a based on the position information of the document origin Op. The CPU 100 can perform the reading correction assuredly and highly accurately by correcting the deviation of the image data depending on the calculated offset amount of the sheet for adjustment T.

In the present embodiment, the multi-function peripheral 1 includes the image forming unit 5 configured to print the reference mark M on the sheet for adjustment T. Thus, the CPU 100 can perform the scanning correction by using the sheet for adjustment T printed by the multi-function peripheral 1 itself by using the image forming unit 5 included in the multi-function peripheral 1.

Note that, the image forming unit 5 includes the ejection head 5a configured to eject ink, and prints the reference mark M on the sheet for adjustment T with the ink. The image forming unit 5 may be further configured to print a mark to be used for performing ejection correction of the ejection head on the sheet for adjustment T. Based on such configuration, in a case where the multi-function peripheral 1 includes the image forming unit 5 of the ink-jet system, the sheet for adjustment T may be used as the sheet for performing the scanning correction as well as the sheet for performing the ejection correction of the ejection head. Note that, the mark to be used for performing the ejection correction of the ejection head described above is an example of a second mark.

Note that, the recording sheet R based on which the sheet for adjustment T is to be prepared is sufficient, if the recording sheet R has two edges having high reliability regarding orthogonality therebetween and each has high reliability regarding straightness. Entire size and entire shape of the recording sheet R based on which the sheet for adjustment T is to be prepared may not comply with the standard of the standard-sized-paper. For example, the recording sheet R based on which the sheet for adjustment T is to be prepared may be larger than the standard size, may have a curved edge as an edge other than the above two edges, or the entire shape thereof may be a right triangle or a polygon.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the above embodiment, the determining process for the reference mark M may be performed in any manner for determining that the candidate portion for the reference mark M is the predetermined reference mark Mo. Further, the determining process for the reference mark M may be omitted.

The flow chart illustrated in each of FIG. 13 and FIG. 14 does not limit the present disclosure to the procedure illustrated in the above flow. The procedure(s) may be added or deleted, and the order of the procedures may be changed within a range not deviating from intention and a technical concept of the disclosure.

Other than the aspects described above, the method of the above embodiment or the modifications may be used in appropriate combination.

Other than the aspect described above, although examples will not be described one by one, the present disclosure may be embodied with various modifications within the range not deviating from intention of the present disclosure.

What is claimed is:

1. A reading apparatus, comprising:
a transparent plate;
a reader; and
a controller,
wherein the controller is configured to perform:
an image generating process of reading an object placed on the transparent plate with scanning by the reader so as to generate an image corresponding to a result of the reading;
a mark reading process of reading at least one first mark arranged overlapping with an edge of a sheet for adjustment placed on the transparent plate with the reader together with a region outside the sheet for adjustment;
an extracting process of extracting at least one edge point on the edge of the sheet for adjustment based on the at least one first mark; and
a correcting process of correcting a deviation in the image corresponding to the result of the reading generated in the image generating process based on position information of the at least one edge point extracted in the extracting process.

2. The reading apparatus according to claim 1, wherein:
the controller is further configured to perform a determining process of determining whether the at least one first mark read in the mark reading process is a predetermined mark; and
the controller is configured to extract, in the extracting process, the at least one edge point on the edge of the sheet for adjustment based on the at least one first mark determined as the predetermined mark in the determining process.

3. The reading apparatus according to claim 1, wherein, in the extracting process, the controller is configured to extract two edge points on a single edge of the sheet for adjustment, as the extracting of the at least one edge point on the edge of the sheet for adjustment.

4. The reading apparatus according to claim 3, wherein, in the extracting process, the controller is configured to extract two first edge points on a first edge located at one side, in a sub-scanning direction of the reader, of the sheet for adjustment placed on the transparent plate, as the extracting of the two edge points on the single edge of the sheet for adjustment.

5. The reading apparatus according to claim 4, wherein, in the correcting process, the controller is configured to correct a shearing deviation of the image corresponding to the result of the reading, based on position information of the two first edge points extracted in the extracting process.

6. The reading apparatus according to claim 4, wherein, in the extracting process, the controller is configured to further extract two second edge points on a second edge, of the sheet for adjustment, orthogonal to the first edge.

7. The reading apparatus according to claim 6, wherein, in the correcting process, the controller is configured to correct a rotational deviation of the image corresponding to the result of the reading, based on position information of the two first edge points and the two second edge points extracted in the extracting process.

8. The reading apparatus according to claim 7, wherein, in the correcting process, the controller is configured to correct the rotational deviation of the image corresponding to the result of the reading, and then correct a shearing deviation of the image corresponding to the result of the reading based on position information of the two first edge points extracted in the extracting process.

9. The reading apparatus according to claim 6 further comprising a contact part to be used for performing positioning in a case where the object and the sheet for adjustment are placed on the transparent plate, wherein:
the contact part includes:
a first contact part disposed at one side, in a main scanning direction orthogonal to the sub-scanning direction of the reader, of the transparent plate; and
a second contact part disposed at the one side, in the sub-scanning direction of the reader, of the transparent plate; and
the controller is configured to extract, in the extracting process, one of the two first edge points on the first edge closer to the first contact part than remaining one of the two first edge points, and one of the two second edge points on the second edge closer to the second contact part than remaining one of the two second edge points.

10. The reading apparatus according to claim 1, wherein the controller is configured to:
extract, in the extracting process, at least one objective edge point on an objective edge located at one side, in a sub-scanning direction of the reader, of the sheet for adjustment placed on the transparent plate, as the extracting of the at least one edge point on the edge of the sheet for adjustment; and
correct, in the correcting process, a deviation in the sub-scanning direction of the image corresponding to the result of the reading based on position information of the at least one objective edge point extracted in the extracting process.

11. The reading apparatus according to claim 10, wherein the controller is configured to:
extract, in the extracting process, two objective edge points on the objective edge of the sheet for adjustment as the at least one objective edge point; and
correct, in the correcting process, the deviation in the sub-scanning direction of the image corresponding to the result of the reading based on position information of the two objective edge points extracted in the extracting process.

12. The reading apparatus according to claim 1, wherein the controller is configured to:
extract, in the extracting process, at least one objective edge point on an objective edge located at one side, in a main scanning direction of the reader, of the sheet for adjustment placed on the transparent plate, as the extracting of the at least one edge point on the edge of the sheet for adjustment; and
correct, in the correcting process, a deviation in the main scanning direction of the image corresponding to the result of the reading based on position information of the at least one objective edge point extracted in the extracting process.

13. The reading apparatus according to claim 12, wherein the controller is configured to:
extract, in the extracting process, the at least one objective edge point based on the first mark located at a first region of the sheet for adjustment, the first region being one of two regions obtained by dividing the sheet for adjustment into two regions in the sub-scanning direction of the reader; and
correct, in the correcting process, the deviation in the main scanning direction of the image corresponding to the result of the reading based on position information of the at least one objective edge points extracted in the extracting process.

14. The reading apparatus according to claim 3, wherein the controller is configured to:
extract, in the extracting process, two first edge points on a first edge located at one side, in a sub-scanning direction of the reader, of the sheet for adjustment placed on the transparent plate and two second edge points on a second edge located at one side, in a main scanning direction of the reader, of the sheet for adjustment placed on the transparent plate, as the extracting of the at least one edge point on the edge of the sheet for adjustment; and
correct, in the correcting process, a deviation in at least one of the sub-scanning direction and the main scanning direction of the image corresponding to the result of the reading based on position information of an intersection of a first straight line connecting the two first edge points on the first edge and a second straight line connecting the two second edge points on the second edge.

15. The reading apparatus according to claim 1, wherein the controller is configured to:
extract, in the extracting process, two objective edge points on an objective edge located at one side, in a main scanning direction of the reader, of the sheet for adjustment placed on the transparent plate, as the extracting of the at least one edge point on the edge of the sheet for adjustment; and
correct, in the correcting process, a rotational deviation of the image corresponding to the result of the reading, based on position information of the two objective edge points extracted in the extracting process.

16. The reading apparatus according to claim 1, wherein the controller is configured to:
extract, in the extracting process, two first edge points on a first edge located at one side, in a sub-scanning direction of the reader, of the sheet for adjustment placed on the transparent plate and two second edge points on a second edge located at one side, in a main scanning direction of the reader, of the sheet for adjustment placed on the transparent plate, as the extracting of the at least one edge point on the edge of the sheet for adjustment; and
correct, in the correcting process, a shearing deviation of the image corresponding to the result of the reading, based on position information of the two first edge points and the two second edge points extracted in the extracting process.

17. The reading apparatus according to claim 1, further comprising a printing unit.

18. The reading apparatus according to claim 17, wherein:
the printing unit includes a head;
the printing unit is configured to print a pattern of the sheet for adjustment on a sheet by ink ejected from the head; and
the pattern of the sheet for adjustment includes the first mark and a second mark to be used for performing ejection correcting of the head.

19. A reading method to be performed by a reading apparatus including a transparent plate and a reader, the method comprising:
an image generating process of reading an object placed on the transparent plate with scanning by the reader so as to generate an image corresponding to a result of the reading;
a mark reading process of reading at least one first mark arranged overlapping with an edge of a sheet for adjustment placed on the transparent plate with the reader together with a region outside the sheet for adjustment;
an extracting process of extracting at least one edge point on the edge of the sheet for adjustment based on the at least one first mark; and
a correcting process of correcting a deviation in the image corresponding to the result of the reading generated in the image generating process based on position information of the at least one edge point extracted in the extracting process.

20. A non-transitory and computer-readable medium storing a program to be executed by a controller of a reading apparatus including a transparent plate, a reader, and the controller, the program is configured to cause the controller to perform:
an image generating process of reading an object placed on the transparent plate with scanning by the reader so as to generate an image corresponding to a result of the reading;
a mark reading process of reading at least one first mark arranged overlapping with an edge of a sheet for adjustment placed on the transparent plate with the reader together with a region outside the sheet for adjustment;
an extracting process of extracting at least one edge point on the edge of the sheet for adjustment based on the at least one first mark; and
a correcting process of correcting a deviation in the image corresponding to the result of the reading generated in the image generating process based on position information of the at least one edge point extracted in the extracting process.
